(19) United States
(12) Patent Application Publication
(10) Pub. No.: US 2020/0180130 A1
(43) Pub. Date: Jun. 11, 2020

(54) DRIVING APPARATUS AND METHOD FOR USING A DRIVING APPARATUS

(71) Applicant: HILTI AKTIENGESELLSCHAFT, Schaan (LI)

(72) Inventors: Iwan Wolf, Untervaz (CH); Joaquin Herrero Fernandez, St. Gallen (CH)

(21) Appl. No.: 16/621,165

(22) PCT Filed: Jul. 30, 2018
(86) PCT No.: PCT/EP2018/070537

§ 371 Date: Dec. 10, 2019

(30) Foreign Application Priority Data
Aug. 7, 2017 (EP) 17185074.6

(51) Int. Cl. B25C 1/00; B25C 1/06

(52) U.S. Cl. CPC B25C 1/008; B25C 1/06

(57) ABSTRACT

An apparatus for driving a fastening element into a substrate, having a trigger switch, which is actuated by a user of the apparatus and, when the trigger switch is actuated, generates a trigger signal, a motion sensor, which generates a wake-up signal when there is a predetermined movement of the apparatus by the user, and an electronic control device, which in an operating mode is suitable for setting the apparatus to a ready-for-driving state, in which a trigger signal of the trigger switch triggers an operation of driving a fastening element into a substrate, and in a standby mode is suitable for receiving a wake-up signal from the motion sensor and, when it receives a wake-up signal, switching from the standby mode to the operating mode.

### TECHNICAL FIELD

The application relates to an apparatus for driving a fastening element into a substrate and to a method for using such an apparatus.

### PRIOR ART

Such apparatuses usually have a piston for transmitting energy to the fastening element. The energy required for this must be made available in a very short time, which is why, in the case of so-called spring nailers, first a spring is tensioned, and then, during the driving operation, the spring imparts the tensile energy to the piston in a sudden burst and accelerates it onto the fastening element. For this purpose, the spring is tensioned by means of a tensioning device, which for its part is powered by a storage battery.

If the apparatus is not used for a predetermined period of time, it automatically changes to a standby mode, in which the spring is relaxed. After that, if a fastening element is to be driven into a substrate, the apparatus first has to be switched on again and changed to an operating mode. This takes time, in particular if a user first attempts to ascertain whether the apparatus is in the operating mode or in the standby mode by trying it out.

The object of the invention is to make it easier for the apparatus mentioned at the beginning to be operated.

### SUMMARY OF THE INVENTION

The object is achieved in the case of an apparatus for driving a fastening element into a substrate, having a trigger switch, which is actuated by a user of the apparatus and, when the trigger switch is actuated, generates a trigger signal, a motion sensor, which generates a wake-up signal when there is a predetermined movement of the apparatus by the user, and an electronic control device, which in an operating mode is suitable for setting the apparatus to a ready-for-driving state, in which a trigger signal of the trigger switch triggers an operation of driving a fastening element into a substrate, and in a standby mode is suitable for receiving a wake-up signal from the motion sensor and, when it receives a wake-up signal, switching from the standby mode to the operating mode. This dispenses with the need to switch on the device if it is in the standby mode. Preferably, the electronic control device is unsuitable for triggering an operation of driving a fastening element into a substrate in the standby mode.

In the context of the invention, the trigger signal and/or the wake-up signal are mechanical, optical, electrical or similar signals that are suitable for being received by the electronic control device.

Preferably, the predetermined movement of the apparatus by the user is a movement that the user carries out with the apparatus each time before actuating the trigger switch. This dispenses with the need for trying out whether the apparatus is in the operating mode or in the standby mode. Particularly preferably, the predetermined movement of the apparatus by the user comprises pressing the apparatus against the substrate. Similarly preferably, the motion sensor comprises a contact pressure sensor.

Preferably, the apparatus has a mechanical energy store for storing mechanical energy and an energy transmission device for transmitting energy from an electrical energy source to the mechanical energy store. Particularly preferably, the electronic control device is supplied with electrical energy by the electrical energy source.

Preferably, the energy transmission device comprises an electric motor. Similarly preferably, the apparatus comprises an energy transmission element that can be moved between a starting position and a setting position for transmitting energy from the mechanical energy store to the fastening element. Particularly preferably, the mechanical energy store comprises a spring, in particular a helical spring.

The object is likewise achieved by a method for using an apparatus for driving a fastening element into a substrate, having a trigger switch, a motion sensor and an electronic control device, wherein in the method the electronic control device is set to a standby mode, a predetermined movement of the apparatus is carried out by a user, a wake-up signal is generated by the motion sensor as a result of the predetermined movement of the apparatus and is received by the electronic control device, as a result of receiving the wake-up signal the electronic control device is set to an operating mode, in which the electronic control device sets the apparatus to a ready-for-driving state, the trigger switch is actuated by the user, a trigger signal is generated by the trigger switch as a result of being actuated, and an operation of driving a fastening element into the substrate is triggered as a result of the trigger signal of the trigger switch.

Preferably, the predetermined movement of the apparatus by the user is a movement that the user carries out with the apparatus each time before actuating the trigger switch. Particularly preferably, the predetermined movement of the apparatus by the user comprises pressing the apparatus against the substrate. Preferably, the electronic control device is supplied with electrical energy by an electrical energy source of the apparatus.

### EXEMPLARY EMBODIMENTS

Exemplary embodiments of an apparatus for driving a fastening element into a substrate are explained in more detail below on the basis of examples with reference to the drawings, in which:

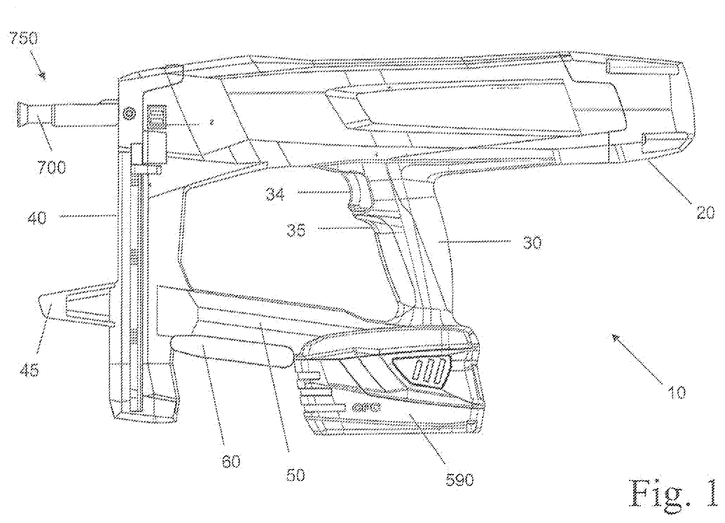

FIG. 1 shows a side view of a driving apparatus, and

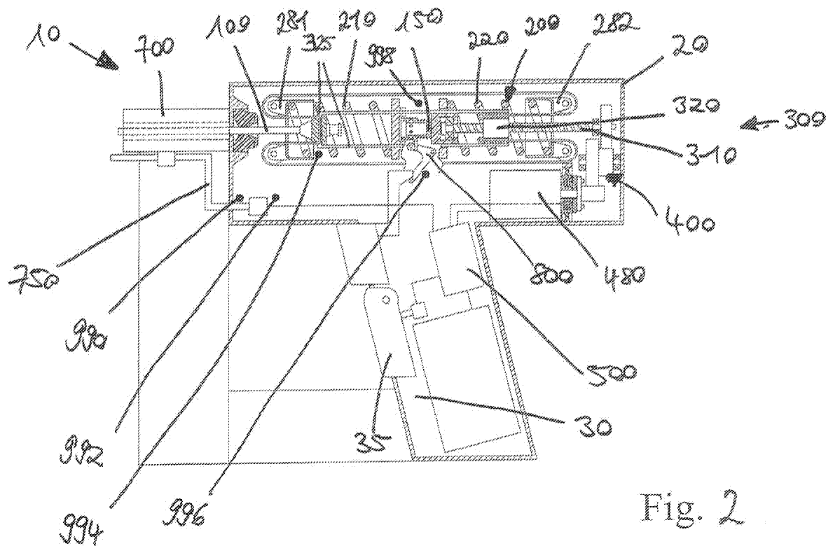

FIG. 2 shows a structural diagram of a driving apparatus.

FIG. 1 shows in a side view a driving apparatus 10 for driving a fastening element, for example a nail or bolt, into a substrate. The driving apparatus 10 has an energy transmission element (not represented) for transmitting energy to the fastening element and also a housing 20 containing the energy transmission element and a drive device (likewise not represented) for transporting the energy transmission element.

The driving apparatus 10 also has a handle 30, a magazine 40 and a bridge 50 connecting the handle 30 to the magazine 40. The magazine is not removable. Attached to the bridge 50 are a scaffold hook 60 for suspending the driving apparatus 10 on a scaffold or the like, and an electrical energy store designed as a storage battery 590. Arranged on the handle 30 are a trigger switch 34, designed as a trigger, for a user's forefinger and a resting surface 35 for the user's other fingers of the same hand. Furthermore, the driving apparatus 10 has a guide channel 700 for guiding the fastening element and a pressing device 750 for detecting a distance of the driving apparatus 10 from a substrate (not represented). Aligning the driving apparatus perpendicularly to a substrate is assisted by an alignment aid 45.

FIG. 2 shows a schematic view of a driving apparatus 10. The driving apparatus 10 comprises a housing 20 containing a piston 100, a clutch device 150 kept closed by a holding element designed as a pawl 800, a spring 200 having a front spring element 210 and a rear spring element 220, a roller train 260 having a force deflector designed as a band 270, a front roller holder 281 and a rear roller holder 282, a spindle drive 300 with a spindle 310 and a spindle nut 320, a transmission 400, a motor 480 and a control device 500 supplied with electrical energy by the storage battery 590. In the case of an exemplary embodiment that is not shown, the force deflector takes the form of a cable.

The driving apparatus 10 has furthermore a guide channel 700 for the fastening element and a pressing device 750. The pressing device 750 consists essentially of a rigid linkage, which altogether moves to the rear, that is to say to the right in FIG. 2, when the driving apparatus 10 is pressed against a substrate. In addition, the housing 20 has a handle 30, on which a resting surface 35 is arranged.

The control device 500 communicates with the manual switch 35 as well as with a number of sensors 990, 992, 994, 996, 998 in order to detect the operating state of the driving apparatus 10. The 990, 992, 994, 996, 998 each have a Hall probe, which detects the movement of a magnet armature (not represented), which is arranged, in particular attached, on the element respectively to be detected.

With the guide channel sensor 990, a forward movement of the pressing device 750 is detected, thereby indicating that the guide channel 700 has been removed from the driving apparatus 10. With the contact pressure sensor 992, a rearward movement of the pressing device 750 is detected, thereby indicating that the driving apparatus 10 is pressed against a substrate. With the roller holder sensor, a movement of the front roller holder 281 is detected, thereby indicating whether the spring 200 is tensioned. With the pawl sensor 996, a movement of the pawl 800 is detected, thereby indicating whether the clutch device 150 is kept in its closed state. Finally, with the spindle sensor 998, it is detected whether the spindle nut 320 or a return rod attached to the spindle nut 320 is in its rearmost position.

For example, the contact pressure sensor 992 serves as a motion sensor which generates a contact pressure signal and transmits it to the control device 500 when the driving apparatus 10 is pressed against a substrate and the pressing device 750 is moved backward relative to the rest of the driving apparatus 10. The control device 500 then sets the apparatus 10 to a ready-for-driving state by causing a tensioning process, in which initially electric current from the battery 590 is applied to the motor 480, so that the motor 480 drives the spindle 310 via the transmission 400, whereby the spindle nut 320 first moves the piston 100 by means of the hooks 325 from a fully forward setting position to the rear, that is to say to the right in FIG. 2, until the piston 100 engages in the clutch device 150. The piston 100 is then in a starting position. Subsequently, the direction of rotation of the motor 480 is reversed, whereby the spindle nut 320 draws the band 270 forward, that is to say to the left in FIG. 2. As a result, the roller holders 281, 282 are moved toward one another, so that the spring elements 210, 220 are tensioned.

A driving operation is triggered by the control device 500 if it is in an operating mode and if the trigger switch 34 is actuated by a user and generates a trigger signal and transmits it to the control device 500. For this purpose, the control device 500 for its part sends a corresponding signal to the pawl 800, which then opens the clutch device 150 in order to release the piston 100. In the case of exemplary embodiments that are not shown, the pawl is mechanically actuated by the trigger switch to open the clutch device. The force of the then relaxing spring elements 210, 220 is thereby deflected by the band 270 and transmitted to the piston 100, so that the piston 100 is accelerated forward. However, the driving operation is only triggered when the control device has a contact pressure signal from the contact pressure sensor 992. This ensures that the driving apparatus 10 can only be triggered when it is pressed against a substrate.

The control device 500 changes from the operating mode to a standby mode when no sensor signals are transmitted to the control device 500 during a predetermined time period of for example six minutes, that is to say when the driving apparatus 10 is not used during the predetermined period of time. In the standby mode, energy consumption of the control device 500 is reduced and it is unsuitable for triggering a driving operation. If the spring elements 210, 220 are tensioned, they are relaxed in a controlled manner in a relaxing process during the changeover to the standby mode. The predetermined period of time can preferably be set by a user of the driving apparatus 10, for example by means of an input device of the driving apparatus 10 or by means of an external input device connected to the driving apparatus 10 via Bluetooth or the like, such as a smartphone app.

The contact pressure signal of the contact pressure sensor 992 serves at the same time as a wake-up signal, which can be received by the control device 500 even in the standby mode. When the wake-up signal is received, the control device 500 reverts to the operating mode, in which it immediately causes a tensioning process because of the contact pressure signal that is present, in order to set the apparatus 10 to a ready-for-driving state, as described above. The driving apparatus 10 is therefore ready for driving within the duration of the tensioning process, without it having to be switched on by the user, for example by means of a switch. The tensioning process preferably takes less than a second.

A bolt guide sensor also preferably provides the information as to whether a bolt guide is attached to or removed from the tip of the apparatus. A trigger sensor preferably provides the information as to whether the trigger has been pulled. A piston sensor preferably provides the information as to whether the energy transmission element is in its starting position or in the setting position. A band sensor preferably provides the information as to whether the force transmitting element is in a tensioned position or in a relaxed position. Hall sensors, inductive sensors or switches, capacitive sensors or switches or mechanical switches are used for example as sensors. Preferably, the driving apparatus has a flexible printed circuit board, to which some or all of the sensors are attached and via which the sensors are connected to the control device. This facilitates the mounting of the sensors during the manufacture of the driving apparatus.

The control device preferably comprises a processor, particularly preferably a microprocessor, for processing the sensor signals and/or other data, in particular information about currents, voltages and the temperature of the electronics. A sensor board preferably processes the sensor signals, in particular of the spindle sensor, of the roll holder sensor, of the pawl sensor, of the bolt guide sensor or of the contact pressure sensor. For a transmission of the sensor signals from the sensors to the control device, the driving apparatus comprises electrical signal lines, which in each case connect a sensor to the control device. A motor control device preferably processes the signal for the motor commutation. The storage battery control arranged in the storage battery preferably processes information about the temperature, the type, the state of charge as well as possibly occurring disturbances of the battery.

In addition, the control device preferably processes the temperature of the motor, the electronics, the ambient air and/or the battery, wherein the signal for the battery temperature can also be used for the identification of a battery fault by battery electronics arranged in the battery. In addition, the control device preferably processes the current drawn from the battery, the current strength of individual commutated phases, the voltage applied to the battery contacts, the voltage applied to the intermediate circuit of a power bridge, the voltage applied to individual components, in particular sensors, and/or the rotational speed of the motor, wherein the rotational speed of the motor is detected for example on the basis of the switched commutation steps, on the basis of a mutual induction or by means of position sensors and/or switches in the motor. Preferably, the control device communicates with a battery control in the battery. In particular, information such as a power requirement, a number of completed cycles with the battery used, a state of charge, the type, the maximum current or voltage in each case of the battery is exchanged.

All of the information mentioned is additionally displayed to the user of the driving apparatus, for example by a screen or one or more light-emitting diodes. In particular, it is indicated to the user whether the driving apparatus is in the operating mode or in the standby mode.

In order that an optimized tensioning process is possible during tensioning even with different battery states and different batteries, the power to the motor is preferably controlled in dependence on the voltage applied to the battery contacts and/or to the intermediate circuit. The full power is applied to the motor until the voltage has fallen to a defined value, for example 12 V. If this value is reached, the control reduces the power and adjusts to this voltage value. In order that the currents to the motor are not too high in the case of a powerful battery, a current limiting control is additionally used, ensuring that a predetermined current is not exceeded. These control systems allow the operation of the apparatus to be ensured and optimized with respect to low voltage even in spite of differences in the power of the batteries. These parameters can be adapted by the control for different battery types and states.

1. An apparatus for driving a fastening element into a substrate, the apparatus having
a trigger switch, which is actuated by a user of the apparatus and, when the trigger switch is actuated, generates a trigger signal,
a motion sensor, which generates a wake-up signal when there is a predetermined movement of the apparatus by the user,
and an electronic control device, which in an operating mode is suitable for setting the apparatus to a ready-for-driving state, in which a trigger signal of the trigger switch triggers an operation of driving the fastening element into the substrate, and in a standby mode is suitable for receiving a wake-up signal from the motion sensor and, when it receives a wake-up signal, switching from the standby mode to the operating mode.

2. The apparatus as claimed in claim 1, wherein the electronic control device is unsuitable for triggering an operation of driving a fastening element into a substrate in the standby mode.

3. The apparatus as claimed in claim 1, wherein the predetermined movement of the apparatus by the user is a movement that the user carries out with the apparatus each time before actuating the trigger switch.

4. The apparatus as claimed in claim 3, wherein the predetermined movement of the apparatus by the user comprises pressing the apparatus against the substrate.

5. The apparatus as claimed in claim 1, wherein the motion sensor comprises a contact pressure sensor.

6. The apparatus as claimed in claim 1, further comprising a mechanical energy store for storing mechanical energy and an energy transmission device for transmitting energy from an electrical energy source to the mechanical energy store.

7. The apparatus as claimed in claim 1, wherein the electronic control device is supplied with electrical energy by the electrical energy source.

8. The apparatus as claimed in claim 6, wherein the energy transmission device comprises an electric motor.

9. The apparatus as claimed in claim 1, further comprising an energy transmission element that can be moved between a starting position and a setting position for transmitting energy from the mechanical energy store to the fastening element.

10. The apparatus as claimed in claim 6, wherein the mechanical energy store comprises a spring.

11. A method for using an apparatus for driving a fastening element into a substrate, the apparatus having a trigger switch, a motion sensor and an electronic control device, comprising
setting the electronic control device to a standby mode,
carrying out a predetermined movement of the apparatus by a user,
generating a wake-up signal by the motion sensor as a result of the predetermined movement of the apparatus,
receiving the wake-up signal by the electronic control device,
setting the electronic control device to an operating mode as a result of receiving the wake-up signal,
setting the apparatus to a ready-for-driving state by the electronic control device,
actuating the trigger switch by the user,
generating a trigger signal by the trigger switch as a result of being actuated,
triggering an operation of driving the fastening element into the substrate as a result of the trigger signal of the trigger switch.

12. The method as claimed in claim 11, wherein the predetermined movement of the apparatus by the user is a movement that the user carries out with the apparatus each time before actuating the trigger switch.

13. The method as claimed in claim 12, wherein the predetermined movement of the apparatus by the user comprises pressing the apparatus against the substrate.

14. The method as claimed in claim 11, comprising supplying the electronic control device with electrical energy by an electrical energy source of the apparatus.

15. The apparatus of claim 10, wherein the spring comprises a helical spring.

16. The apparatus as claimed in claim 2, wherein the predetermined movement of the apparatus by the user is a movement that the user carries out with the apparatus each time before actuating the trigger switch.

17. The apparatus as claimed in claim 2, wherein the motion sensor comprises a contact pressure sensor.

18. The apparatus as claimed in claim 2, further comprising a mechanical energy store for storing mechanical energy and an energy transmission device for transmitting energy from an electrical energy source to the mechanical energy store.

19. The apparatus as claimed in claim 2, wherein the electronic control device is supplied with electrical energy by the electrical energy source.

20. The apparatus as claimed in claim 2, wherein the energy transmission device comprises an electric motor.
